(19) United States
(12) Patent Application Publication
(10) Pub. No.: US 2021/0211035 A1
(43) Pub. Date: Jul. 8, 2021

(54) APPARATUS INCLUDING A ROTATIONAL DEVICE FOR USE IN GENERATING ELECTRICAL POWER

(71) Applicants: Jorge Antonio Cordero Gomez del Campo, Las Vegas, NV (US); Jorge Antonio Cordero Palau, Col la alcantarilla (MX)

(72) Inventors: Jorge Antonio Cordero Gomez del Campo, Las Vegas, NV (US); Jorge Antonio Cordero Palau, Col la alcantarilla (MX)

(21) Appl. No.: 17/138,524

(22) Filed: Dec. 30, 2020

Related U.S. Application Data
(60) Provisional application No. 62/956,497, filed on Jan. 2, 2020.

(51) Int. Cl. H02K 53/00; H02K 5/12

(52) U.S. Cl. CPC H02K 53/00; H02K 5/12

(57) ABSTRACT

A system for use in generating electrical power, is described herein. The system includes an electrical power generator and a rotor assembly coupled to the electrical power generator. The rotor assembly includes a housing that defines a chamber containing a volume of liquid and a rotational device rotatably mounted to the housing. The rotational device includes a rotor coupled to a rotor shaft. The rotor shaft is coupled to the electrical power generator. The rotor includes a first portion positioned within the chamber and a second portion positioned outside of the chamber. The first portion of the rotor is submerged within the volume of liquid such that a upward buoyancy force exerted by the volume of liquid acts upon the first portion of the rotor to cause a rotation of the rotational device about an axis of rotation.

### CROSS REFERENCE TO RELATED APPLICATION

This application claims the benefit of U.S. Provisional Application No. 62/956,497, filed on Jan. 2, 2020, the disclosure of which is hereby incorporated by reference in its entirety for all purposes.

### FIELD OF THE DISCLOSURE

The present invention relates generally to a system for use in generating electrical power.

### BACKGROUND OF THE INVENTION

At least some known power generating systems include gas turbine engines that ignite fuel to generate combustion gases that are then directed to a rotor assembly to cause the rotor assembly to rotate a rotor shaft that is coupled to an electrical power generator. However, these known gas turbine engines generate significant exhaust gases that may be harmful to the environment. As such, a power generating system that does not generate environmentally harmful exhaust gases is desired.

The present invention addresses one or more of the aforementioned challenges.

### SUMMARY OF THE INVENTION

In different embodiments of the present invention, a system and apparatus for generating electrical power, are provided.

In one aspect of the present invention, a system for use in generating electrical power, is provided. The system includes an electrical power generator and a rotor assembly coupled to the electrical power generator. The rotor assembly includes a housing that defines a chamber containing a volume of liquid and a rotational device rotatably mounted to the housing. The rotational device includes a rotor coupled to a rotor shaft. The rotor shaft is coupled to the electrical power generator. The rotor includes a first portion positioned within the chamber and a second portion positioned outside of the chamber. The first portion of the rotor is submerged within the volume of liquid such that a upward buoyancy force exerted by the volume of liquid acts upon the first portion of the rotor to cause a rotation of the rotational device about an axis of rotation.

In another aspect of the present invention, a rotor assembly is provided. The rotor assembly includes a housing that defines a chamber containing a volume of liquid and a rotational device rotatably mounted to the housing. The rotational device includes a rotor coupled to a rotor shaft. The rotor shaft is coupled to an electrical power generator. A first portion of the rotor is positioned within the chamber and a second portion of the rotor is positioned outside of the chamber. The first portion of the rotor being submerged within the volume of liquid such that a upward buoyancy force exerted by the volume of liquid acts upon the first portion of the rotor to cause a rotation of the rotational device about an axis of rotation.

In yet another aspect of the present invention, a method of assembling a system for use in generating electrical power is provided. The method includes the steps of providing a housing that defines a chamber containing a volume of liquid, mounting a rotational device to the housing with the rotational device including a rotor coupled to a rotor shaft, and coupling the rotor shaft to an electrical power generator. A first portion of the rotor is positioned within the chamber and a second portion of the rotor is positioned outside of the chamber. The first portion of the rotor being submerged within the volume of liquid such that a upward buoyancy force exerted by the volume of liquid acts upon the first portion of the rotor to cause a rotation of the rotational device about an axis of rotation.

### BRIEF DESCRIPTION OF THE FIGURES

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIG. 1 is a side elevation view of an apparatus for use in generating electrical power, according to the present invention;

FIG. 2 is a sectional view of the apparatus shown in FIG. 1 taken along line 2-2; and

FIG. 3 is a flow chart illustrating a method of assembling a system for use in generating electrical power, according to one embodiment of the present invention.

Corresponding reference characters indicate corresponding components throughout the several views of the drawings.

### DETAILED DESCRIPTION

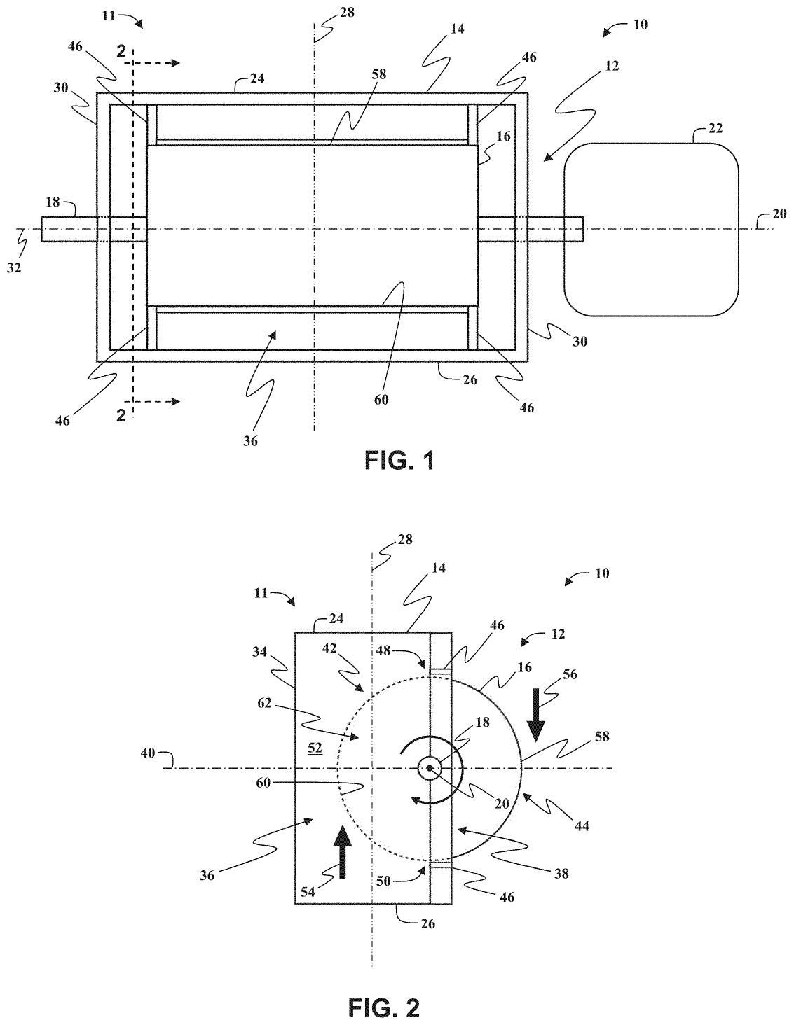

With reference to the FIGS. and in operation, the present invention provides an apparatus that includes a rotational device for use in generating electrical power. Referring to FIGS. 1-2, the numeral 10 generally designates a system including an apparatus for use in generating electrical power. The system 10 includes an apparatus including a rotor assembly 11 that includes a rotational device 12 rotatably mounted to a recipient housing 14. The rotational device 12 includes a rotor 16 having a rotor shaft 18 that is rotatably mounted to the recipient housing 14 and is rotatable about an axis of rotation 20. The rotor shaft 18 is also coupled to an electrical power generator 22 and rotatably drives generator 22 such that the rotation of the rotational device 12 facilitates production of electrical power by the generator 22.

The recipient housing 14 includes a top wall 24, a bottom wall 26 spaced from the top wall 24 along a vertical axis 28, a pair of opposing end walls 30 coupled between the top wall 24 and the bottom wall 26 and spaced along a horizontal axis 32, and a side wall 34 that is coupled between the top wall 24, the bottom wall 26, and the end walls 30 to form a chamber 36 having an open end 38.

The rotor shaft 18 is rotationally supported by the end walls 30 and is spaced a distance from the side wall 34 along a transverse axis 40 that is perpendicular to the horizontal axis 32 and the vertical axis 28. The rotor shaft 18 is positioned adjacent the open end 38 of the housing 14 such that a first portion 42 of the rotor 16 is positioned within the chamber 36 and a second portion 44 of the rotor 16 is positioned outside of the chamber 36.

A plurality of seals 46 are positioned between the top wall 24 of the housing and a top portion 48 of the rotor 16, and between the bottom wall 26 of the housing and a bottom portion 50 of the rotor 16 to enclose a volume of liquid 52 within the chamber 36. The first portion 42 of the rotor 16 is submerged within the volume of liquid 52 such that a upward buoyancy force 54 exerted by the liquid 52 acts upon the first portion 42 of the rotor 16 to cause a rotation of the rotational device 12 about the axis of rotation 20.

The recipient housing 14 may hold any type of liquid including, but not limited to, mercury, water, etc. The flotation of the rotational device 12 produces the force that rotates the rotor 16. The recipient housing 14 can be built of any material that prevents the liquid from leaking from the chamber 36, or reduces liquid leakage from the chamber 36, due to the extreme close tolerances between the recipient housing 14 and an outer surface of the rotor 16. Alternatively, the seals 46 may be specifically designed for this purpose. In some embodiments, the walls of the recipient housing 14 and/or seals 46 may be built or covered with Teflon™, or any other suitable material.

The rotor 16 may have any shape and/or form, can be solid, or partially solid, solid on the outer part of the circumference, can be filled with air, or any other gas or liquid suitable for this purpose. For example, in the illustrated embodiment, the rotor 16 includes an outer surface 58 defining a substantially cylindrical shape extending along the axis of rotation 20. The rotor 16 may also include an inner surface 60 defining an interior chamber 62 therein. The interior chamber 62 may be configured to contain a volume of air, or any other suitable gas or liquid.

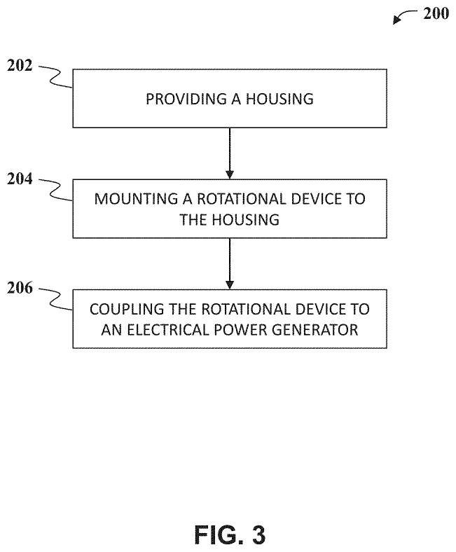

Referring to FIG. 3, in some embodiments, the present invention includes a method 200 of assembling the system 10 for use in generating electrical power. The method 200 includes providing 202 a housing 14 that defines a chamber 36 containing a volume of liquid 52. The method 200 also includes mounting 204 a rotational device 12 to the housing 14. The rotational device 12 includes a rotor 16 coupled to a rotor shaft 18. The method 200 also includes coupling 206 the rotor shaft 18 to an electrical power generator 22. The rotational device 12 is mounted within the housing 14 such that a first portion 42 of the rotor 16 is positioned within the chamber 36 and a second portion 44 of the rotor 16 is positioned outside of the chamber 36. The first portion 42 of the rotor 16 is submerged within the volume of liquid 52 such that a upward buoyancy force 54 exerted by the volume of liquid 52 acts upon the first portion 42 of the rotor 16 to cause a rotation of the rotational device 12 about the axis of rotation 20.

During operation, flotation of a portion of the rotational device 12 in the liquid (e.g. mercury) within the recipient housing 14 produces the upward buoyancy force 54, which along with the downward gravitational force 56, rotates the rotor 16 about the axis of rotation 20. The rotational device 12 uses the opposing gravitational and buoyancy forces to produce rotational movement by having more weight only in one half of the circumference of the rotor 16 to be used to generate power. In some embodiments, the rotor 16 includes a center-of-gravity that is offset from the axis of rotation 20. For example, the rotor assembly 11 may include a rotor 16 including a disk with half of the disk lighter than the other. In one embodiment, the disk may be fully immersed, providing the greater weight difference, however, the disk may also be partially immersed in other levels of liquid.

In some embodiments, the system 10 is configured to use flotation to produce and upward force in part of the rotational device 12, in such a way that gravity can produce a complementary downward force on the opposite part of the rotational device 12. The combination of flotation and gravitation to produce rotation on any mechanical device, such as the rotational device 12 described herein. The system 10 also has an enormous amount of applications, on anything that requires mechanical power, as well as to generate electricity.

The above description of illustrated examples of the present invention are not intended to be exhaustive or to be limitation to the precise forms disclosed. While specific embodiments of, and examples for, the invention are described herein for illustrative purposes, various equivalent modifications are possible without departing from the broader spirit and scope of the present invention. Obviously, many modifications and variations of the present invention are possible in light of the above teachings. The invention may be practiced otherwise than as specifically described within the scope of the appended claims.

Although specific features of various embodiments of the disclosure may be shown in some drawings and not in others, this is for convenience only. In accordance with the principles of the disclosure, any feature of a drawing or other embodiment may be referenced and/or claimed in combination with any feature of any other drawing or embodiment.

This written description uses examples to describe embodiments of the disclosure and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for use in generating electrical power, comprising:
an electrical power generator; and
a rotor assembly coupled to the electrical power generator, the rotor assembly including:
a housing defining a chamber containing a volume of liquid; and
a rotational device rotatably mounted to the housing and including a rotor coupled to a rotor shaft;
wherein the rotor shaft is coupled to the electrical power generator; and
wherein a first portion of the rotor is positioned within the chamber and a second portion of the rotor is positioned outside of the chamber, the first portion of the rotor being submerged within the volume of liquid such that a upward buoyancy force exerted by the volume of liquid acts upon the first portion of the rotor to cause a rotation of the rotational device about an axis of rotation.

2. The system of claim 1, wherein the housing includes a top wall, a bottom wall spaced from the top wall along a vertical axis, a pair of opposing end walls coupled between the top wall and the bottom wall and spaced along a horizontal axis, and a side wall coupled between the top wall, the bottom wall, and the end walls to form the chamber having an open end.

3. The system of claim 2, wherein the rotor shaft is rotationally supported by the end walls and is positioned adjacent the open end of the housing, the rotor is coupled to the rotor shaft such that the first portion of the rotor is positioned within the chamber and the second portion of the rotor is positioned outside of the chamber.

4. The system of claim 2, wherein the housing includes a plurality of seals positioned between the top wall of the housing and a top portion of the rotor and between the bottom wall of the housing and a bottom portion of the rotor to enclose the volume of liquid within the chamber.

5. The system of claim 1, wherein the volume of liquid includes mercury.

6. The system of claim 1, wherein the rotor includes an outer surface defining a substantially cylindrical shape.

7. The system of claim 6, wherein the rotor includes a center-of-gravity that is offset from the axis of rotation.

8. The system of claim 6, wherein the rotor includes an inner surface defining an interior chamber therein.

9. A rotor assembly, comprising:
a housing defining a chamber containing a volume of liquid; and
a rotational device rotatably mounted to the housing and including a rotor coupled to a rotor shaft;
wherein the rotor shaft is coupled to an electrical power generator; and
wherein a first portion of the rotor is positioned within the chamber and a second portion of the rotor is positioned outside of the chamber, the first portion of the rotor being submerged within the volume of liquid such that a upward buoyancy force exerted by the volume of liquid acts upon the first portion of the rotor to cause a rotation of the rotational device about an axis of rotation.

10. The rotor assembly of claim 9, wherein the housing includes a top wall, a bottom wall spaced from the top wall along a vertical axis, a pair of opposing end walls coupled between the top wall and the bottom wall and spaced along a horizontal axis, and a side wall coupled between the top wall, the bottom wall, and the end walls to form the chamber having an open end.

11. The rotor assembly of claim 10, wherein the rotor shaft is rotationally supported by the end walls and is positioned adjacent the open end of the housing, the rotor is coupled to the rotor shaft such that the first portion of the rotor is positioned within the chamber and the second portion of the rotor is positioned outside of the chamber.

12. The rotor assembly of claim 10, wherein the housing includes a plurality of seals positioned between the top wall of the housing and a top portion of the rotor and between the bottom wall of the housing and a bottom portion of the rotor to enclose the volume of liquid within the chamber.

13. The rotor assembly of claim 9, wherein the volume of liquid includes mercury.

14. The rotor assembly of claim 9, wherein the rotor includes an outer surface defining a substantially cylindrical shape.

15. The rotor assembly of claim 14, wherein the rotor includes a center-of-gravity that is offset from the axis of rotation.

16. The rotor assembly of claim 14, wherein the rotor includes an inner surface defining an interior chamber therein.

17. A method of assembling a system for use in generating electrical power, the method comprising the steps of:
providing a housing defining a chamber containing a volume of liquid;
mounting a rotational device to the housing, the rotational device including a rotor coupled to a rotor shaft; and
coupling the rotor shaft to an electrical power generator; and
wherein a first portion of the rotor is positioned within the chamber and a second portion of the rotor is positioned outside of the chamber, the first portion of the rotor being submerged within the volume of liquid such that a upward buoyancy force exerted by the volume of liquid acts upon the first portion of the rotor to cause a rotation of the rotational device about an axis of rotation.

18. The method of claim 17, wherein the housing includes a top wall, a bottom wall spaced from the top wall along a vertical axis, a pair of opposing end walls coupled between the top wall and the bottom wall and spaced along a horizontal axis, and a side wall coupled between the top wall, the bottom wall, and the end walls to form the chamber having an open end.

19. The method of claim 18, wherein the rotor shaft is rotationally supported by the end walls and is positioned adjacent the open end of the housing, the rotor is coupled to the rotor shaft such that the first portion of the rotor is positioned within the chamber and the second portion of the rotor is positioned outside of the chamber.

20. The method of claim 18, wherein the housing includes a plurality of seals positioned between the top wall of the housing and a top portion of the rotor and between the bottom wall of the housing and a bottom portion of the rotor to enclose the volume of liquid within the chamber.
